(19) United States
(12) Patent Application Publication
(10) Pub. No.: US 2025/0184970 A1
(43) Pub. Date: Jun. 5, 2025

(54) TIME OR SPATIAL DOMAIN BEAM PREDICTION SYSTEMS

(71) Applicant: QUALCOMM Incorporated, San Diego, CA (US)

(72) Inventors: Qiaoyu LI, Beijing (CN); Sony AKKARAKARAN, Poway, CA (US); Mahmoud TAHERZADEH BOROUJENI, San Diego, CA (US); Tao LUO, San Diego, CA (US)

(21) Appl. No.: 18/845,847

(22) PCT Filed: May 27, 2022
(86) PCT No.: PCT/CN2022/095503

§ 371 Date: Sep. 10, 2024

(51) Int. Cl. H04W 72/044; H04B 17/318; H04L 25/02; H04W 64/00

(52) U.S. Cl. CPC H04W 72/044; H04B 17/328; H04L 25/0202; H04W 64/003

(57) ABSTRACT

A first UE may receive an indication to operate in at least one of a TD beam prediction mode or an SD beam prediction mode. The indication may be received from a first network entity. A second UE may obtain side information associated with the second UE for at least one of the TD beam prediction mode or the SD beam prediction mode. The second UE may transmit the side information associated with the second UE. The first UE may receive the side information from at least one of the first network entity, the second UE, or a second network entity. The first UE may estimate, based on the side information, one or more channel characteristics for a first set of DL RSs based on at least one of the TD beam prediction mode or the SD beam prediction mode.

### TECHNICAL FIELD

The present disclosure relates generally to communication systems, and more particularly, to a wireless beam property prediction system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may have a memory and at least one processor coupled to the memory at a first user equipment (UE). Based at least in part on information stored in the memory, the at least one processor may be configured to receive an indication to operate in at least one of a time domain (TD) beam prediction mode or a spatial domain (SD) beam prediction mode. The indication may be received from a first network entity. Based at least in part on information stored in the memory, the at least one processor may be further configured to receive side information associated with a second UE. The side information may be received from at least one of the first network entity, the second UE, or a second network entity. Based at least in part on information stored in the memory, the at least one processor may be further configured to estimate, based on the side information, one or more channel characteristics for a first set of downlink (DL) reference signals (RSs) based on at least one of the TD beam prediction mode or the SD beam prediction mode.

In an aspect of the disclosure, a method, a computer-readable medium, and an apparatus are provided. The apparatus may have a memory and at least one processor coupled to the memory at a second user equipment (UE). Based at least in part on information stored in the memory, the at least one processor may be configured to obtain side information associated with the second UE for at least one of TD beam prediction mode or an SD beam prediction mode. Based at least in part on information stored in the memory, the at least one processor may be further configured to transmit the side information associated with the second UE.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 are diagrams illustrating example aspects of slot structures that may be used for sidelink communication.

FIG. 5 is a diagram illustrating an example of a machine learning (ML) prediction system.

FIG. 6 is a diagram illustrating a machine learning (ML) system operating in a TD beam prediction mode

FIG. 7A is a diagram illustrating an ML system operating in an SD beam prediction mode.

FIG. 7B is a diagram illustrating another ML system operating in an SD beam prediction mode.

FIG. 8 is a connection flow diagram illustrating a UE configured to estimate channel characteristics using side information received from one or more wireless devices.

FIG. 9 is a diagram illustrating an example of a UE configured to collect side information to estimate characteristics of a reference signal from a network entity.

FIG. 10 is a diagram illustrating another example of a UE configured to collect side information to estimate characteristics of a reference signal from a network entity.

FIG. 11 is a flowchart of a method of wireless communication.

FIG. 12 is another flowchart of a method of wireless communication.

FIG. 13 is another flowchart of a method of wireless communication.

FIG. 14 is another flowchart of a method of wireless communication.

FIG. 15 is another flowchart of a method of wireless communication.

FIG. 16 is a diagram illustrating an example of a hardware implementation for an example apparatus and/or network entity.

FIG. 17 is a diagram illustrating an example of a hardware implementation for an example network entity.

### DETAILED DESCRIPTION

It may be difficult to completely model environments that a UE may encounter in the future via conventional statistical signaling processing methods to predict beam conditions, even when using a prediction model. Relying on UE measurements may lead to degraded prediction accuracy. By utilizing side information from other wireless devices, a UE may be able to provide better predicted characteristics. For example, side information about other neighboring UEs' predicted beam blockage instances or beam quality environment characteristics, together with the location information of the neighboring UEs, may provide better predicted characteristics for a UE that may be traveling towards or away from the neighboring UE's location, or that may be moving towards or away from environmental conditions similar to the neighboring UE. Prediction models for beam prediction may utilize such side information as inputs to improve its performance.

A UE may be configured with prediction models and/or algorithms to provide TD, SD, and TD and SD predicted beam characteristics. A prediction model may use side information inputs from a network entity and/or one or more neighboring UEs. A UE may be configured to collect such information via a sidelink connection. For example, a first UE may receive an indication to operate in at least one of a TD beam prediction mode or an SD beam prediction mode. The indication may be received from a first network entity. A second UE may obtain side information associated with the second UE for at least one of the TD beam prediction mode or the SD beam prediction mode. The second UE may transmit the side information associated with the second UE. The first UE may receive the side information from at least one of the first network entity, the second UE, or a second network entity. The first UE may estimate, based on the side information, one or more channel characteristics for a first set of DL RSs based on at least one of the TD beam prediction mode or the SD beam prediction mode.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

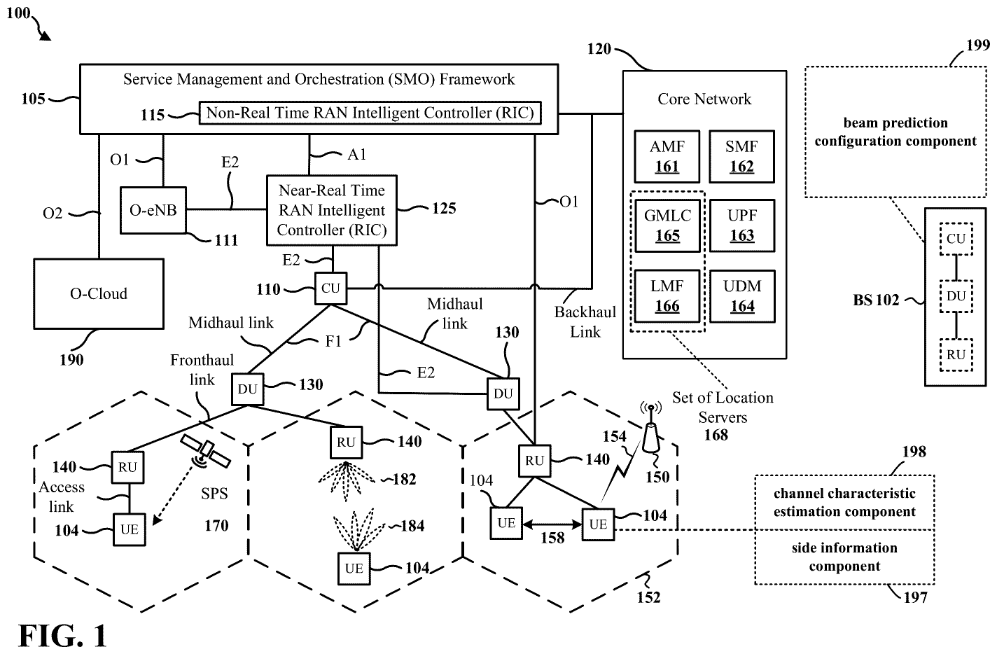

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to receive an indication to operate in at least one of a TD beam prediction mode or an SD beam prediction mode via channel characteristic estimation component 198. The indication may be received from a first network entity. The channel characteristic estimation component 198 may receive side information associated with a second UE from at least one of the first network entity, the second UE, or a second network entity. The channel characteristic estimation component 198 may estimate, based on the side information, one or more channel characteristics for a first set of DL RSs based on at least one of the TD beam prediction mode or the SD beam prediction mode. In certain aspects, the UE 104 may be configured to obtain side information associated with itself for at least one of a TD beam prediction mode or an SD beam prediction mode via side information component 197. The side information component 197 may transmit the side information associated with the UE 104. In certain aspects, the base station 102 may be configured to transmit an indication to operate in at least one of a TD beam prediction mode or an SD beam prediction mode to a UE via beam prediction configuration component 199. The beam prediction configuration component 199 may obtain side information from a UE 104. The beam prediction configuration component 199 may transmit that side information to another UE 104. Although the following description may be focused on 5G NR, the concepts described herein may be applicable to other similar areas, such as LTE, LTE-A, CDMA, GSM, evolved-universal terrestrial radio access (E-UTRAN) NR dual connectivity (EN-DC) and other wireless technologies.

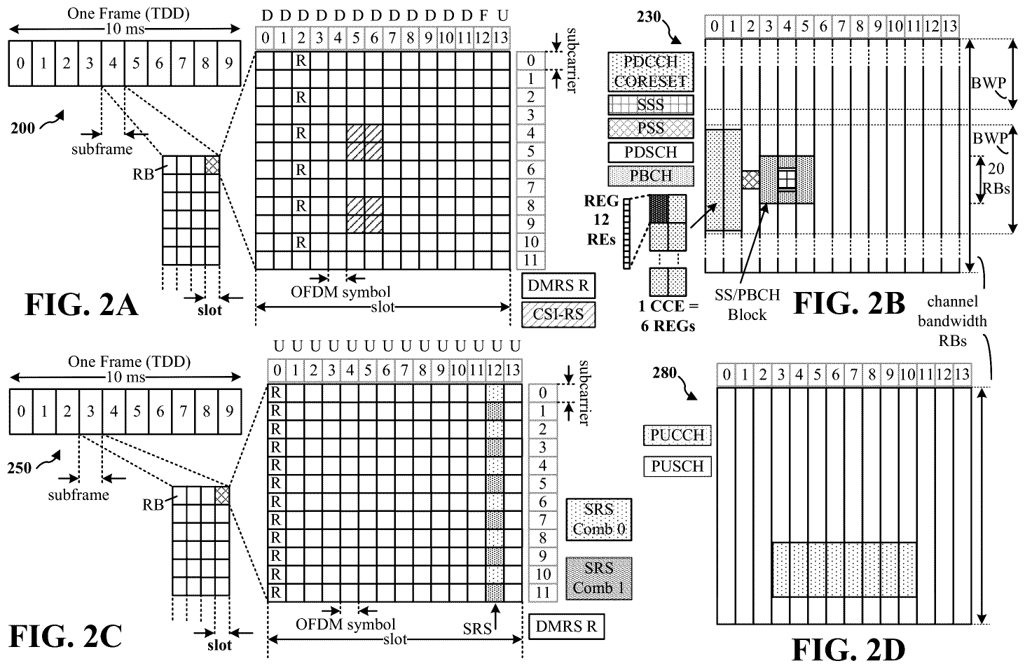

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

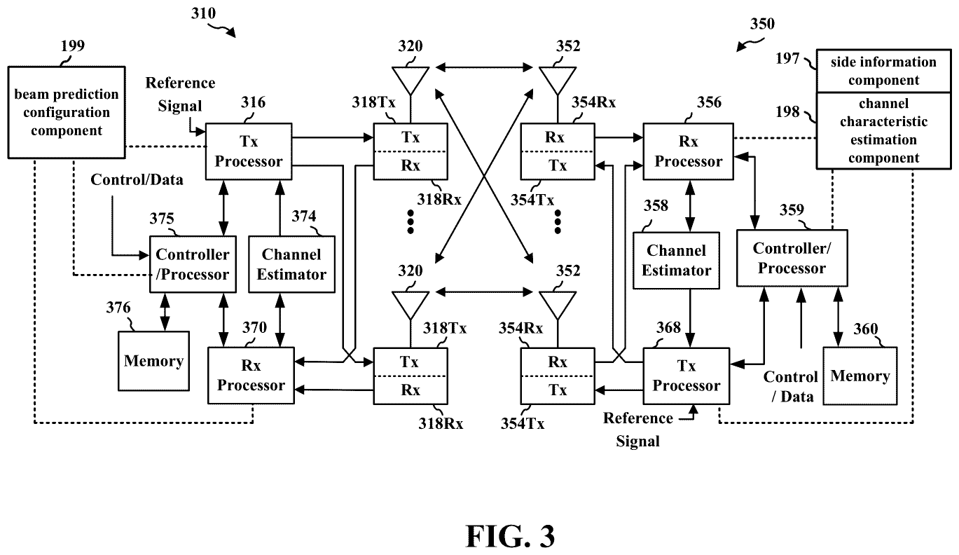

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the channel characteristic estimation component 198 of FIG. 1.

At least one of the Tx processor 368, the Rx processor 356, and the controller/processor 359 may be configured to perform aspects in connection with the side information component 197 of FIG. 1.

At least one of the Tx processor 316, the Rx processor 370, and the controller/processor 375 may be configured to perform aspects in connection with the beam prediction configuration component 199 of FIG. 1.

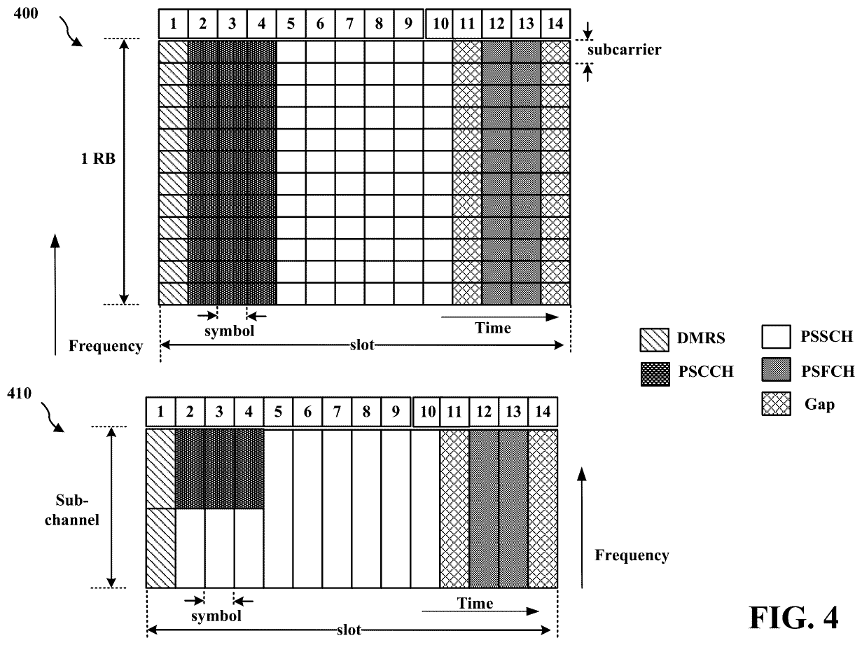

FIG. 4 includes diagrams 400 and 410 illustrating example aspects of slot structures that may be used for sidelink communication (e.g., between UEs 104). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 4 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 400 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 410 in FIG. 4 illustrates an example in which the PSCCH occupies about 50% of a subchannel, as one example to illustrate the concept of PSCCH occupying a portion of a subchannel. The physical sidelink shared channel (PSCCH) occupies at least one subchannel. The PSCCH may include a first portion of sidelink control information (SCI), and the PSCCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 4, some of the REs may include control information in PSCCH and some REs may include demodulation RS (DMRS). At least one symbol may be used for feedback. FIG. 4 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DMRS, SCI, feedback, gap symbols, and/or LBT symbols may be different than the example illustrated in FIG. 4. Multiple slots may be aggregated together in some aspects.

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSc), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 4. Although the following description, including the example slot structure of FIG. 4, may provide examples for sidelink communication in connection with 5G NR, the concepts described herein may be applicable to other similar areas, such as LTE, LTE-A, CDMA, GSM, and other wireless technologies.

Referring again to FIG. 1, in certain aspects, the UE 104 may be configured to communicate with each other using a D2D link 158 within a communication zone, such as zone 152. The communication may be based on a slot structure including aspects described in connection with FIG. 4. For example, the UE 104 may transmit a sidelink transmission that includes, for example, a control channel (e.g., PSCCH) and/or a corresponding data channel (e.g., PSCCH), that may be received by another UE 104. A control channel may include information (e.g., sidelink control information (SCI)) for decoding the data channel including reservation information, such as information about time and/or frequency resources that are reserved for the data channel transmission. For example, the SCI may indicate a number of TTIs, as well as the RBs that will be occupied by the data transmission. The SCI may also be used by receiving devices to avoid interference by refraining from transmitting on the reserved resources. A UE 104 may each be capable of sidelink transmission in addition to sidelink reception.

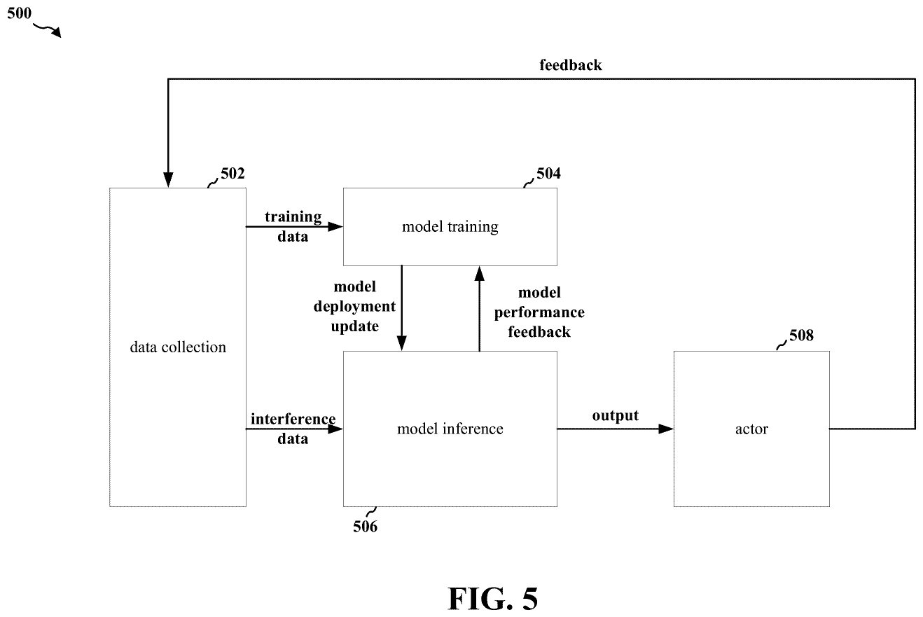

Data collected by a UE may be used to train a machine learning (ML) and/or an artificial intelligence (AI) system. FIG. 5 is a diagram 500 illustrating an aspect of an ML prediction system. An AI and/or an ML algorithm may be used to prepare data. For example, data pre-processing and cleaning, formatting, and/or transformation algorithms may be applied to collected data. Such algorithms may or may not be applied by the data collection function 502. Data collected by the data collection function 502 may include, for example, measurements from a UE, measurements and/or reports from other network entities (e.g., an RU, an RSU), feedback from the actor function 508, and/or an output from another ML prediction system. The data collection function 502 may provide input data to a model training function 504 and/or a model inference function 506.

The model training function 504 may train a ML model, may validate a ML model, and/or may test a ML model. The model training function 504 may generate model performing metrics as part of its model testing procedure(s). The model training function 504 may also prepare data, for example by applying data pre-processing and cleaning, formatting, and/or transformation algorithms to the data provided by the data collection function 502. The model training function 504 may deploy a new or updated model via a model deployment update to the model inference function 506. The model may be trained, validated, and/or tested by the model training function 504.

The model inference function 506 may provide predictions and/or decisions as an output to an actor function 508. In some aspects, the model inference function 506 may provide model performance feedback to the model training function 504. The model inference function 506 may also prepare data, for example by applying data pre-processing and cleaning, formatting, and/or transformation algorithms to the data provided by the data collection function 502. In some aspects, the actor function 508 or other network entities may provide feedback to the model inference function 506 to create model performance feedback. In some aspects, the feedback may be provided to the data collection function 502, which could then provide aggregated feedback as inference data to the model inference function 506.

The actor function 508 may receive an output from the model inference function 506 to trigger and/or perform actions based upon the output from the model inference function 506. The actor may trigger actions itself (e.g., an actor function on a UE may alter resources used for a transmission based on the output), or the actor may transmit a trigger indication to other entities (e.g., an actor function on a UE may forward a portion of the output to another UE or a network entity). The actor function 508 may provide feedback to the data collection function 502 to allow the data collection function 502 to derive training data, inference data, and/or performance feedback.

Such an ML system or prediction model may be used to predict one or more characteristics of a beam or a channel. While beam qualities and/or failures may be identified via measurements by a UE, such measurements may specify more power and/or overhead resources than a ML prediction system. In addition, the accuracy of such beam measurements may be limited due to restrictions on how much power and/or overhead resources it may use to perform such measurements. Moreover, the more power and/or overhead resources used by a UE to take such measurements, the more latency and throughput resources may be impacted by beam resuming efforts.

A prediction model may be used to predict beam characteristics in a spatial domain (SD), time domain (TD), and/or frequency domain (FD). By predicting beam characteristics using a prediction model, a UE may reduce the amount of power and/or overhead resources it uses, and may also improve its predictive accuracy, latency, and/or throughput. For example, a prediction model that predicts non-measured beam qualities may lower the amount of power and/or overhead a UE uses, and may be more accurate than measurements taken by the UE, particularly if the UE may take measurements using a low power and/or overhead resource threshold. In another aspect, a prediction model that predicts future beam blockage and/or failures may improve beam latency of the UE and/or data throughput of the UE by scheduling around transmission resources that have a high likelihood of being blocked or otherwise failing.

While a network entity, such as a base station, may have more processing power and other overhead resources than a UE, a UE may have more observations (e.g., via measurements), than a network entity in order to predict future DL-Tx beam qualities and/or characteristics. As a result, prediction using a prediction model at a UE may be better than prediction using a prediction model at a network entity. An ML system prediction model may be trained by data collected by a UE, data collected by a network entity, or both. For example, a network entity may collect data via an enhanced air interface and/or via application-layer approaches. A UE may collect data by measuring qualities and/or characteristics of Rx beams, and may perform additional computation and/or buffering, and may use additional data storage in order to train a prediction model.

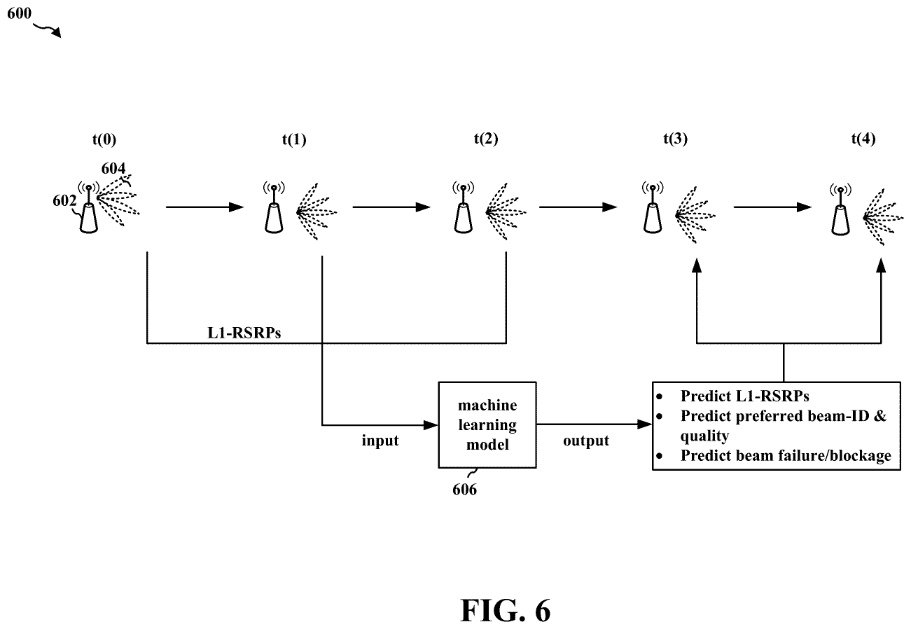

FIG. 6 shows a diagram 600 illustrating an ML system prediction model used to predict beam characteristics based on TD collected data (i.e., operating in a TD beam prediction mode). A network entity 602 may transmit CSI-RS 604, which may be received by a wireless device, such as a UE or a network entity. A UE may measure the CSI-RS 604, while a network entity may use measurements reported by one or more UEs to the network entity. The CSI-RS 604 may be identified by an SSB resource identifier (ID). A UE may measure qualities and/or characteristics of the CSI-RS 604 at a time t(0), a time t(1), and a time t(2). The qualities and/or characteristics may include, for example, level 1 RSRPs of the SSB resources of the CSI-RS 604. A machine learning model 606 may use the L1 RSRPs collected at various time periods to predict one or more channel characteristics for future downlink (DL) reference signals (RSs) at time t(3) and/or time t(4). For example, the machine learning model 606 may predict level 1 RSRPs for the CSI-RS 604 at time t(3) and/or time t(4), the machine learning model 606 may predict a suitable or favored beam ID and possible an associated quality or likelihood that the beam ID will have a stronger RSRP than other beams at time t(3) and/or time t(4), and/or the machine learning model 606 may predict a beam failure or a blockage of a beam at time t(3) and/or time t(4). A beam failure may be determined by a predicted beam level error rate (BLER) meeting or being above a threshold value. A beam failure may be reported as whether the UE has determined that a reference PDCCH may be decoded or not. A beam blockage may be determined by at least a portion of a beam being blocked for a time period (e.g., 5 slots) during a DL RS.

By predicting one or more channel characteristics for one or more DL RSs at future times t(3) and/or t(4), a UE may refine its beam selection process, may improve its link quality (e.g., channel quality indicator (CQI), precoding matrix indicator (PMI)), may predict when a future beam may fail, may predict when a future beam may be blocked, and/or may predict when a radio link failure (RLF) condition may occur. Use of an ML system may result in lower UE power being used since the UE may not need to take as many measurements to predict such characteristics, and may result in the UE using less overhead resources. The UE may also have better latency and throughput by leveraging the predicted characteristics.

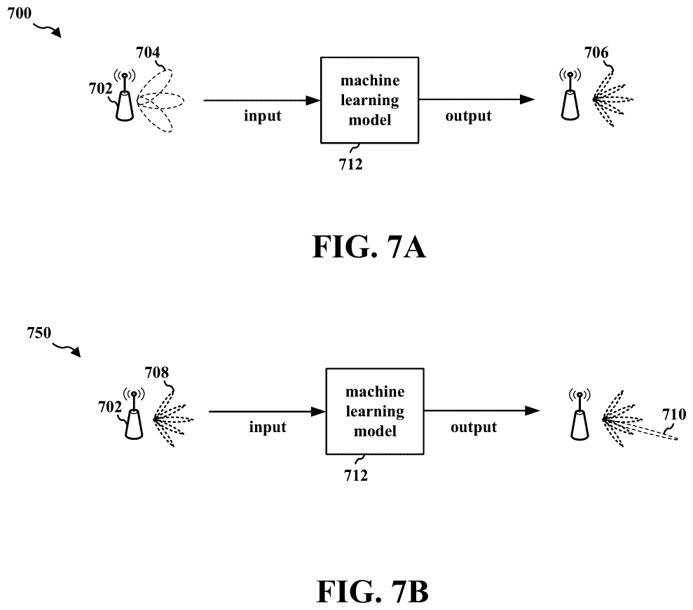

FIG. 7A shows a diagram 700 illustrating an ML system prediction model used to predict beam characteristics based on SD collected data (i.e., operating in an SD beam prediction mode). A network entity 702 may transmit CSI-RS 704, which may be received by a wireless device, such as a UE or a network entity. A UE may measure the CSI-RS 704, while a network entity may use measurements reported by one or more UEs to the network entity. The CSI-RS 704 may be identified by an SSB resource identifier (ID). A UE may measure qualities and/or characteristics of the CSI-RS 704, and may process the measurements using a machine learning model 712 to predict the quality of other beams transmitted by the network entity 702. For example, if the machine learning model 712 analyzes wide beams of the CSI-RS 704, the machine learning model 712 may predict the quality of narrow beams of the CSI-RS 706. If the machine learning model 712 analyzes narrow beams of the CSI-RS 704, the machine learning model 712 may predict the quality of wide beams of the CSI-RS 706. This may refine beam selection latency and/or downlink referencing overhead of the UE. Such outputs may be used to perform codebook (CB) based SD selection.

FIG. 7B shows a diagram 750 illustrating an ML system prediction model used to predict beam characteristics based on SD collected data (i.e., operating in an SD beam prediction mode). A network entity 702 may transmit CSI-RS 708, which may be received by a wireless device, such as a UE or a network entity. A UE may measure the CSI-RS 708, while a network entity may use measurements reported by one or more UEs to the network entity. The CSI-RS 708 may be identified by an SSB resource identifier (ID). A UE may measure qualities and/or characteristics of the CSI-RS 708, and may process the measurements using a machine learning model 712 to predict the quality of other beams transmitted by the network entity 702. For example, if the machine learning model 712 analyzes down sampled spatial domain directional beams of the CSI-RS 708, the machine learning model 712 may predict a suitable or favored direction of non-measured beams 710. This may improve the selection accuracy for the UE. Such outputs may be used to perform non-codebook (NCB) based SD predictions.

An analysis of both TD and SD collected data may be used to predict both TD and SD characteristics. A joint SD and TD beam prediction may be used to predict beam failures/blockages and may be used to predict RLF conditions.

Beam prediction may be a non-linear problem to solve. For example, predicting future Tx beam qualities and/or characteristics may depend upon a UE's moving speed and/or trajectory, Rx beams received by the UE from other wireless devices, and/or a captured interference measurement. As a result, it may be difficult to completely model environments that the UE may encounter in the future via conventional statistical signaling processing methods. Relying on UE measurements may lead to degraded prediction accuracy. For example, for TD beam characteristic predictions, measuring the end-to-end beam qualities at the UE itself may not provide enough real-time data to accurately predict conditions.

By utilizing side information from other wireless devices, a UE using a prediction model to predict beam/channel characteristics may be able to provide better predicted characteristics. For example, side information about other neighboring UEs' predicted beam blockage instances or beam quality environment characteristics, together with the location information of the neighboring UEs, may provide better predicted characteristics for a UE that may be traveling towards or away from the neighboring UE's location, or may be moving towards or away from environmental conditions similar to the neighboring UE. Prediction models for beam prediction may utilize such side information as inputs to improve its performance.

A UE may be configured with prediction models and/or algorithms to provide TD, SD, and TD and SD predicted beam characteristics. A prediction model may be provided side information inputs from a network entity and/or one or more neighboring UEs. A UE may be configured to collect such information via a sidelink connection. For example, a first UE may receive an indication to operate in at least one of a TD beam prediction mode or an SD beam prediction mode. The indication may be received from a first network entity. A second UE may obtain side information associated with the second UE for at least one of the TD beam prediction mode or the SD beam prediction mode. The second UE may transmit the side information associated with the second UE. The first UE may receive the side information from at least one of the first network entity, the second UE, or a second network entity. The first UE may estimate, based on the side information, one or more channel characteristics for a first set of DL RSs based on at least one of the TD beam prediction mode or the SD beam prediction mode.

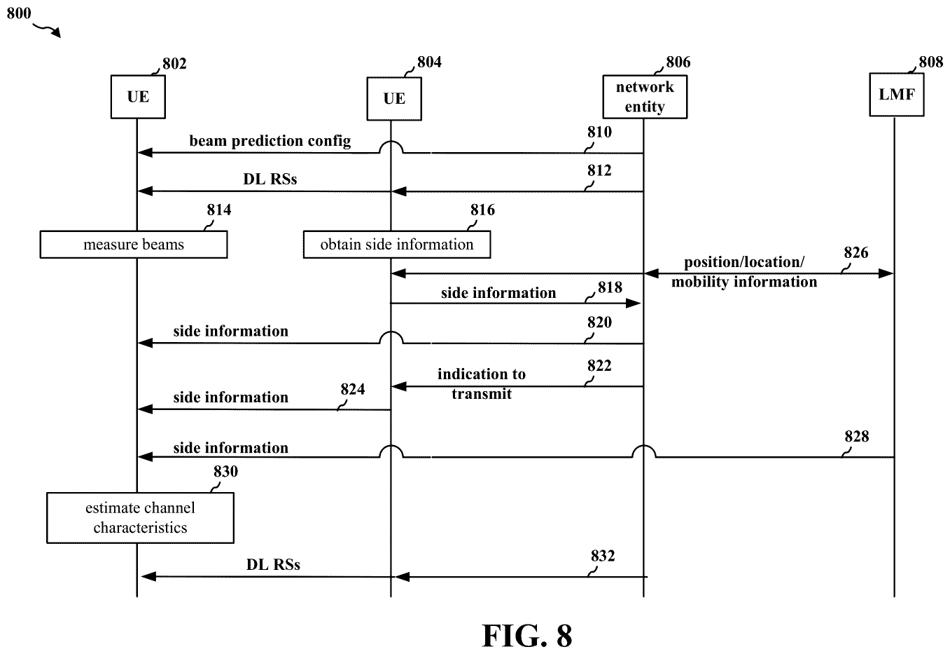

FIG. 8 shows a connection flow diagram 800 illustrating a UE 802 configured to estimate channel characteristics using side information received from one or more wireless devices. A network entity 806 may be configured to transmit a beam prediction configuration 810 to the UE 802. The beam prediction configuration 810 may be provided in any suitable format, such as an RRC configuration, as a medium access control (MAC) control element (MAC-CE), or as DCI. The beam prediction configuration 810 may provide an indicator of when the UE 802 may operate in a TD beam prediction mode, an SD beam prediction mode, and/or a TD and an SD beam prediction mode.

The UE 802 may collect data in one or more ways. For example, the UE 802 may receive the DL RSs 812 from the network entity 806. At 814, the UE 802 may measure one or more beams of the DL RSs 812 to collect information about the DL RSs. For example, the UE 802 may measure a reference signal received power (RSRP), may determine a reference signal (RS) identifier (RS-ID) of one or more beams, may measure characteristics of a beam failure condition (e.g., time when the transmission occurred, an RS-ID of the failed beam, a BLER rate), or a beam blockage condition (e.g., time when the transmission occurred, an RS-ID of the blocked beam, a location of the UE at the time of the blocked condition). One or more of the measured characteristics may be used by the UE 802 as an input to a prediction model to estimate one or more channel characteristics of a set of DL RSs 832 from the network entity 806.

The UE 804 may also receive the DL RSs 812 from the network entity 806. At 816, the UE 802 may obtain side information about the DL RSs 812, for example by measuring one or more beams of the DL RSs 812 to collect information about the DL RSs. The UE 804 may measure a reference signal received power (RSRP), may determine a reference signal (RS) identifier (RS-ID) of one or more beams, may measure characteristics of a beam failure condition (e.g., time when the failed transmission occurred, an RS-ID of the failed beam, a BLER rate), or a beam blockage condition (e.g., time when the transmission occurred, an RS-ID of the blocked beam, a location of the UE at the time of the blocked condition). The UE 804 may save the measured characteristics in a memory of historical characteristics of the DL RSs 812. The UE 804 may also apply at least some of the historical characteristics of the DL RSs to a prediction model to predict one or more characteristics of the DL RSs. The UE 804 may filter such historical and/or predicted characteristics by ones associated with a number of cell-common codec mode requests (CMRs) and/or a number of cell-common beam failure detection (BFD) reference signals (BFD-RSs) between the UE 802 and the UE 804. The UE 804 may identify such associated characteristics by SSBs identified from remaining minimum system information (RMSI).

The UE 804 may construct a channel profile between the UE 804 and the network entity 806 to provide environmental conditions of the UE 804 when measuring one or more of the DL RSs 812. The channel profile may include, for example, at least one of a packet data protocol (PDP) used by the UE 804 and the network entity 806, an angle of arrival (AoA) or a beam between the UE 804 and the network entity 806, or characteristics of a resource used by the UE 804 and the network entity 806 (e.g., raw channel information). The UE 804 may construct a channel profile between the UE 804 and the UE 802 to provide environmental conditions of the UE 804. The channel profile may include, for example, at least one of a sidelink PDP used by the UE 804 and the UE 802, an AoA or a sidelink beam used by the UE 804 and the UE 802, or a resource used by the UE 804 and the UE 802 (e.g., raw sidelink channel information). The UE 804 may collect position information, location information, and/or mobility information. Such information may be obtained using a GNSS fix or from the LMF 808 via position/location/mobility information 826. The position/location/mobility information 826 may be transmitted using a long term evolution (LTE) positioning protocol (LPP) transmission. UE 804 may transmit such side information to the network entity 806 as side information 818. In some aspects, the UE 804 may transmit such side information directly to the UE 802 as side information 824. The UE 804 may transmit the side information 824 to the UE 802 in response to receiving an indication 822 to transmit the side information to the UE 802 from the network entity 806. The indication 822 to transmit the side information may include an encoder for the UE 804 to compress the side information 824. The indication 822 to transmit the side information 824 may be received periodically, semi-periodically, or aperiodically by the UE 802. In some aspects the UE 804 may transmit, broadcast, or multi-cast the side information 824 periodically, for example via PSSCH. The UE 804 may be an RSU or a smart repeater that collects side information from other UEs. At least a portion of the side information 824 received by the UE 802 may be used by the UE 802 as an input to a prediction model to estimate one or more channel characteristics of a set of DL RSs 832 from the network entity 806.

The network entity 806 may transmit side information 820 to the UE 802. The side information 820 may include at least a portion of the side information 818 received from the UE 804. The LMF 808 may transmit position/location/mobility information 826 of one or more UEs to the network entity 806, such as the position/location/mobility information 826 of UE 804, of UE 802, or of a set of UEs within a threshold distance of the UE 802. The side information 820 may include at least a portion of the position/location/mobility information 826 received from the LMF 808. The position/location/mobility information 826 may be transmitted via an LPP transmission. The side information 820 may be transmitted as an RRC configuration, as a MAC-CE, or as DCI. The network entity 806 may compress the side information 820 using an encoder. The side information 820 or the beam prediction configuration 810 may include a decoder for decompressing the side information 824 received by the UE 802 from the UE 804 or the side information 820 received by the UE 802 from the network entity 806. The side information 820 or the beam prediction configuration 810 may include an encoder used by the UE 802 or the network entity 806 to compress the side information 824 or the side information 820, respectively. The UE 802 may use the encoder to decode the side information 824 received by the UE 802 from the UE 804 or the side information 820 received by the UE 802 from the network entity 806. The side information 820 may contain side information aggregated from a set of UEs, for example all UEs known by the network entity 806 to be within a threshold distance of the UE 802. In some aspects the network entity 806 may transmit, broadcast, or multi-cast the side information 820 periodically, for example via PDSCH. At least a portion of the side information 820 received by the UE 802 may be used by the UE 802 as an input to a prediction model to estimate one or more channel characteristics of a set of DL RSs 832 from the network entity 806.

The UE 802 may also receive side information 828 from the LMF 808. The side information 828 from the LMF 808 may include position, location, and/or mobility information of one or more UEs, such as the UE 804, the UE 802, or a set of UEs within a threshold distance of the UE 802. The side information 828 from the LMF 808 may be transmitted via an LPP transmission. At least a portion of the side information 828 received by the UE 802 may be used by the UE 802 as an input to a prediction model to estimate one or more channel characteristics of a set of DL RSs 832 from the network entity 806.

At 830, the UE 802 may estimate one or more channel characteristics of a set of DL RSs from the network entity 806. The UE 802 may use a prediction model, such as an ML system algorithm transmitted to the UE 802 by a network entity that configures ML systems. The UE 802 may receive the prediction model from the network entity 806 or from the UE 804. The UE 802 may apply the prediction model to at least a portion of its collected data, such as beam characteristic information measured at 814 (e.g., from the DL RSs 812), side information 820 received from the network entity 806, side information 824 received from the UE 804, and/or side information 828 received from the LMF 808. The prediction model may then produce an estimate of one or more channel characteristics of a set of DL RSs 832 from the network entity 806.

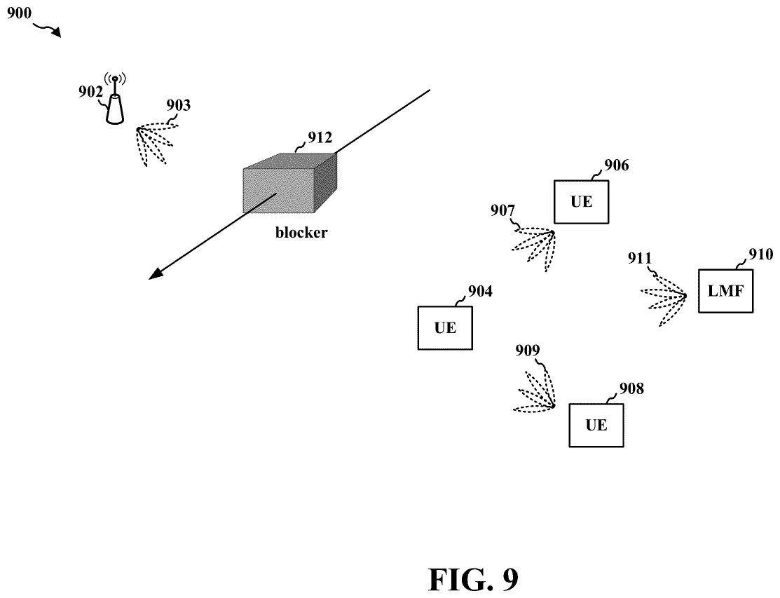

FIG. 9 is a diagram 900 illustrating an example of a UE 904 configured to collect side information via transmission 903 from the network entity 902, transmission 907 from the UE 906, transmission 909 from the UE 908, and transmission 911 from the LMF 910 to estimate characteristics of transmission 903 (e.g., DL RSs) from the network entity 902. The UE 904 may have a prediction model received from an AI/ML model configuration network entity. The UE 904 may utilize received side information to predict a beam blockage from the blocker 912 which may block one or more signals of the transmission 903.

The UE 906 may transmit side information to the UE 904 via transmission 907, which may be a sidelink transmission broadcast or multi-cast periodically from the UE 906. The UE 906 may transmit side information with respect to one or more historical or predicted characteristics on beam failure and/or blockage instances from the network entity 902 regarding a cell-common SSB associated with respective future time instances. For example, the UE 906 may have received an SSB of the transmission 903 having an ID of #3 from the network entity 902. The UE 906 may have had the SSB having an ID of #3 blocked by the blocker 912 at a time period, such as 1 second ago for 400 ms. The UE 906 may broadcast this transmission 907 via sidelink.

The UE 908 may transmit side information to the UE 904 via transmission 909, which may be a sidelink transmission broadcast or multi-cast periodically from the UE 908. The UE 908 may transmit side information with respect to one or more historical or predicted characteristics on beam failure and/or blockage instances from the network entity 902 regarding a cell-common SSB associated with respective future time instances. For example, the UE 908 may predict that a beam blockage condition may occur at a specified future time with respect to a cell-common SSB, such as 300 ms later with respect to an SSB of the transmission 903 having an ID of #3 from the network entity 902 for a duration of 200 ms. The UE 908 may broadcast this transmission 909 via sidelink.

The LMF 910 may transmit side information to the UE 904 via transmission 911, which may be an LPP transmission. The side information may include, for example position, location, and/or mobility information of the UE 906, the UE 908, and/or the UE 904.

The UE 904 may locally measure channel profiles between the UE 904 and the network entity 902 regarding a set of SSBs, which may include the cell-common SSB having an ID of #3 shared by the UE 906 and the UE 908. The UE 904 may use the side information received by the transmission 903 from the network entity 902, the transmission 907 from the UE 906, the transmission 909 from the UE 908, and the transmission 911 from the LMF 910 to predict that a beam blockage condition may occur. For example, the UE 904 may predict that, in 500 ms, a beam blockage condition may occur with respect to the SSB having an ID of #3 of the transmission 903 from the network entity 902 for a duration of 300 ms.

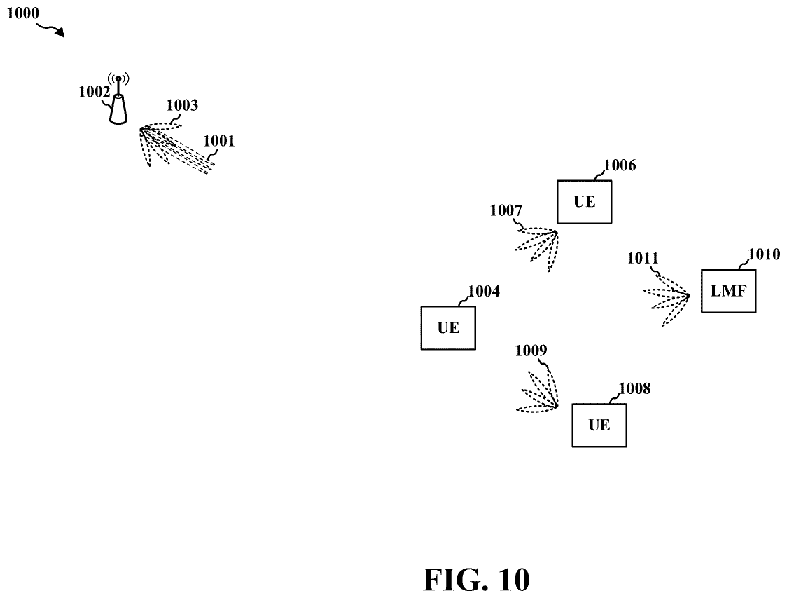

FIG. 10 is a diagram 1000 illustrating an example of a UE 1004 configured to collect side information via transmission 1003 from the network entity 1002, transmission 1007 from the UE 906, transmission 1009 from the UE 1008, and transmission 1011 from the LMF 1010 to estimate characteristics of transmission 1003 (e.g., DL RSs) from the network entity 1002. The UE 1004 may have a prediction model received from an AI/ML model configuration network entity. The UE 1004 may utilize received side information to predict which beams may be the strongest from the network entity 1002. In other words, the UE 1004 may perform TD and/or SD beam quality predictions based on received side information.

The UE 1006 may transmit side information to the UE 1004 via transmission 1007, which may be a sidelink transmission broadcast or multi-cast periodically from the UE 1006. The UE 1006 may transmit side information with respect to one or more historical or predicted strongest SSB identifiers (SSB-IDs) and associated RSRP measurements regarding a set of cell-common SSBs shared by the UE 1004 and the UE 1006. For example, the UE 1006 may transmit a transmission 1007 containing an indication that its strongest cell-common SSB has an ID of #2 with an RSRP of −86 dBm, and which was measured 20 ms ago. The UE 1006 may broadcast this transmission 1007 via sidelink.

The UE 1008 may transmit side information to the UE 1004 via transmission 1009, which may be a sidelink transmission broadcast or multi-cast periodically from the UE 1008. The UE 1008 may transmit side information with respect to one or more historical or predicted strongest SSB identifiers (SSB-IDs) and associated RSRP measurements regarding a set of cell-common SSBs shared by the UE 1004 and the UE 1008. For example, the UE 1008 may transmit a transmission 1009 containing an indication that it predicts that its strongest cell-common SSB will be the SSB with an ID of #3 in 80 ms with a predicted RSRP of −78 dBm. The UE 1008 may broadcast this transmission 1009 via sidelink.

The LMF 1010 may transmit side information to the UE 1004 via transmission 1011, which may be an LPP transmission. The side information may include, for example position, location, and/or mobility information of the UE 1006, the UE 1008, and/or the UE 1004.

The UE 1004 may locally measure channel profiles between the UE 1004 and the network entity 1002 regarding a set of SSBs, which may include the cell-common SSB having an ID of #2 and an ID of #3 shared by the UE 1006 and the UE 1008, respectively. The UE 1004 may use the side information received by the transmission 1003 from the network entity 1002, the transmission 1007 from the UE 1006, the transmission 1009 from the UE 1008, and the transmission 1011 from the LMF 1010 to predict that a future strongest beam. For example, the UE 1004 may predict that, in 30 ms, its strongest SSB will be the SSB with an ID of #2 with a predicted RSRP of −82 dBm. In another aspect, the UE 1004 may predict that, in 40 ms, its strongest CSI-RS identifier (CSI-RS-ID) from the set of CSI-RSs 1001 specifically configured for the UE 1004 will be the CSI-RS-ID #1 with a predicted RSRP of −90 dBm.

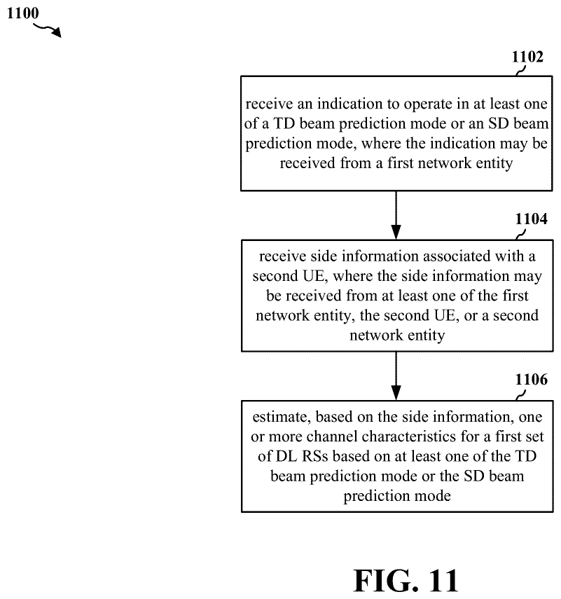

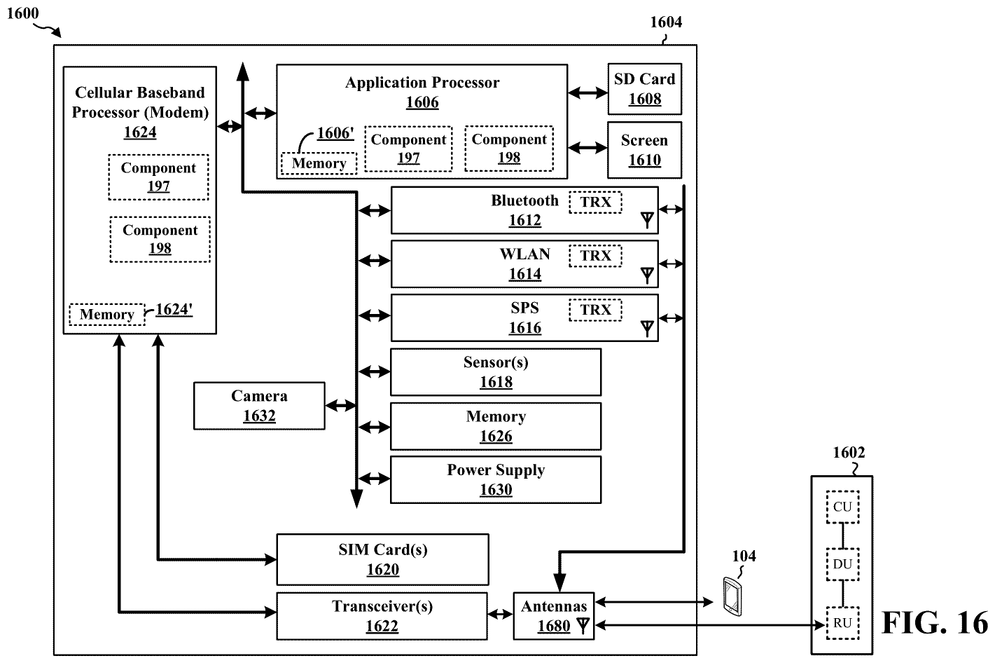

FIG. 11 is a flowchart 1100 of a method of wireless communication. The method may be performed by a first UE (e.g., the UE 104, UE 350, UE 802, UE 804, UE 904, UE 906, UE 908, UE 1004, UE 1006, UE 1008; the apparatus 1604). At 1102, the first UE may receive an indication to operate in at least one of a TD beam prediction mode or an SD beam prediction mode. The indication may be received from a first network entity. For example, 1102 may be performed by the UE 802 in FIG. 8, which may receive an indication to operate in at least one of a TD beam prediction mode or an SD beam prediction mode in the beam prediction configuration 810. The UE 802 may receive the beam prediction configuration 810 from the network entity 806. 1102 may also be performed by component 198 of FIG. 16.

At 1104, the first UE may receive side information associated with a second UE. The side information may be received from at least one of the first network entity, the second UE, or a second network entity. For example, 1104 may be performed by the UE 802 in FIG. 8, which may receive side information 820, 824, or 828 associated with the UE 804. The side information 820 may be received from the network entity 806. The side information 824 may be received from the UE 804. The side information 828 may be received from the LMF 808. 1104 may also be performed by component 198 of FIG. 16.

Finally, at 1106, the first UE may estimate, based on the side information, one or more channel characteristics for a first set of DL RSs based on at least one of the TD beam prediction mode or the SD beam prediction mode. For example, 1106 may be performed the UE 802 in FIG. 8, which, at 830, may estimate, based on the side information 820, side information 824, or the side information 828, one or more channel characteristics for the DL RSs 832 based on at least one of the TD beam prediction mode or the SD beam prediction mode. 1106 may also be performed by component 198 of FIG. 16.

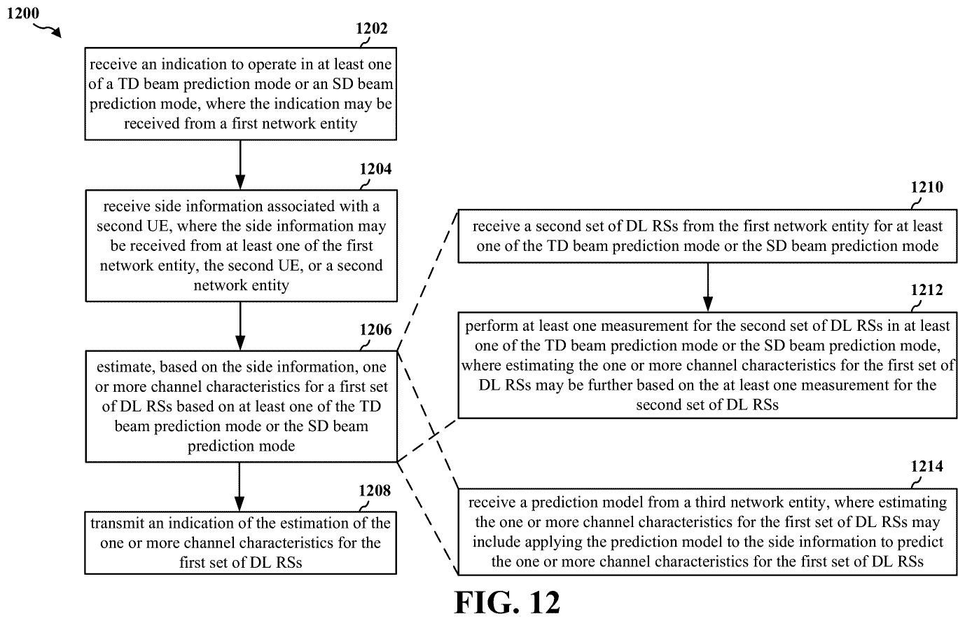

FIG. 12 is a flowchart 1200 of a method of wireless communication. The method may be performed by a first UE (e.g., the UE 104, UE 350, UE 802, UE 804, UE 904, UE 906, UE 908, UE 1004, UE 1006, UE 1008; the apparatus 1604). At 1202, the first UE may receive an indication to operate in at least one of a TD beam prediction mode or an SD beam prediction mode, where the indication may be received from a first network entity. For example, 1202 may be performed by the UE 802 in FIG. 8, which may receive an indication to operate in at least one of a TD beam prediction mode or an SD beam prediction mode in the beam prediction configuration 810. The UE 802 may receive the beam prediction configuration 810 from the network entity 806. 1202 may also be performed by component 198 of FIG. 16.

At 1204, the first UE may receive side information associated with a second UE, where the side information may be received from at least one of the first network entity, the second UE, or a second network entity. For example, 1204 may be performed by the UE 802 in FIG. 8, which may receive side information 820, 824, or 828 associated with the UE 804. The side information 820 may be received from the network entity 806. The side information 824 may be received from the UE 804. The side information 828 may be received from the LMF 808. 1204 may also be performed by component 198 of FIG. 16.

At 1206, the first UE may estimate, based on the side information, one or more channel characteristics for a first set of DL RSs based on at least one of the TD beam prediction mode or the SD beam prediction mode. For example, 1206 may be performed the UE 802 in FIG. 8, which, at 830, may estimate, based on the side information 820, side information 824, or the side information 828, one or more channel characteristics for the DL RSs 832 based on at least one of the TD beam prediction mode or the SD beam prediction mode. 1206 may also be performed by component 198 of FIG. 16.

At 1210, the first UE may receive a second set of DL RSs from the first network entity for at least one of the TD beam prediction mode or the SD beam prediction mode. For example, 1210 may be performed by the UE 802 in FIG. 8, which may receive the DL RSs 812 from the network entity 806 for at least one of the TD beam prediction mode or the SD beam prediction mode. 1210 may also be performed by component 198 of FIG. 16.

At 1212, the first UE may perform at least one measurement for the second set of DL RSs in at least one of the TD beam prediction mode or the SD beam prediction mode. Estimating the one or more channel characteristics for the first set of DL RSs may be further based on the at least one measurement for the second set of DL RSs. For example, 1212 may be performed by the UE 802 in FIG. 8, which, at 814, may perform at least one measurement for the DL RSs 812 from the network entity 806 in in at least one of the TD beam prediction mode or the SD beam prediction mode. At 830, the UE 802 may estimate the one or more channel characteristics for the set of DL RSs 832 based on the at least one measurement for the DL RSs 812. 1212 may also be performed by component 198 of FIG. 16.

At 1214, the first UE may receive a prediction model from a third network entity. Estimating the one or more channel characteristics for the first set of DL RSs may include applying the prediction model to the side information to predict the one or more channel characteristics for the first set of DL RSs. For example, 1214 may be performed by the UE 802 in FIG. 8, which may receive a prediction model from a network entity, such as the network entity 806. At 830, the UE 802 may estimate the one or more channel characteristics for the set of DL RSs 832 by applying the prediction model to the side information 820, the side information 824, or the side information 828, to predict the one or more channel characteristics for the set of DL RSs 832. 1214 may also be performed by component 198 of FIG. 16.

At 1208, the first UE may transmit an indication of the estimation of the one or more channel characteristics for the first set of DL RSs. For example, 1208 may be performed by the UE 804 in FIG. 8, which may transmit an indication of the estimation of the one or more channel characteristics for the DL RSs to the UE 802 as side information 824. 1208 may also be performed by component 198 of FIG. 16.

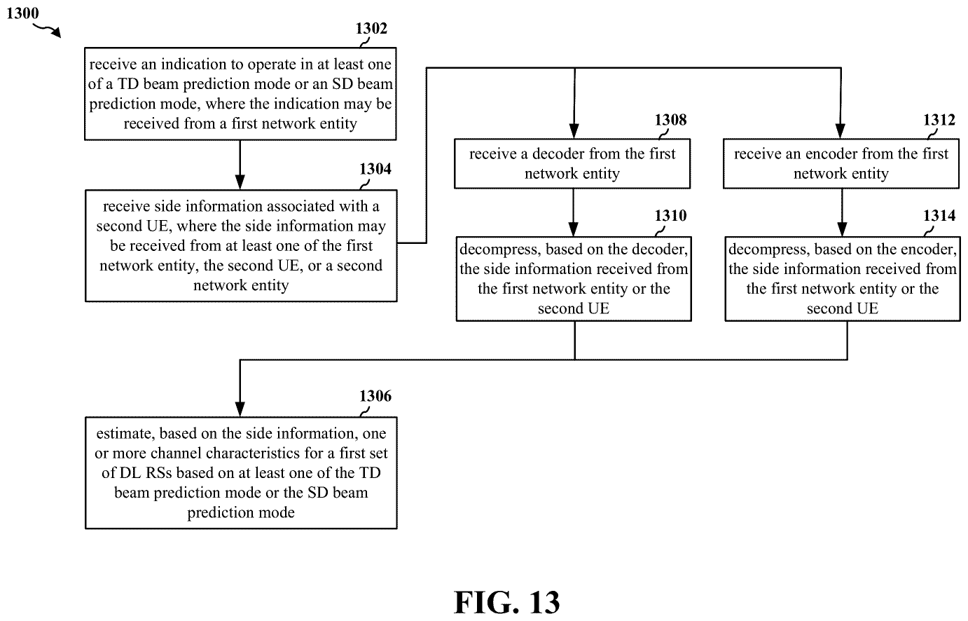

FIG. 13 is a flowchart 1300 of a method of wireless communication. The method may be performed by a first UE (e.g., the UE 104, UE 350, UE 802, UE 804, UE 904, UE 906, UE 908, UE 1004, UE 1006, UE 1008; the apparatus 1604). At 1302, the first UE may receive an indication to operate in at least one of a TD beam prediction mode or an SD beam prediction mode, where the indication may be received from a first network entity. For example, 1302 may be performed by the UE 802 in FIG. 8, which may receive an indication to operate in at least one of a TD beam prediction mode or an SD beam prediction mode in the beam prediction configuration 810. The UE 802 may receive the beam prediction configuration 810 from the network entity 806. 1302 may also be performed by component 198 of FIG. 16.

At 1304, the first UE may receive side information associated with a second UE, where the side information may be received from at least one of the first network entity, the second UE, or a second network entity. For example, 1304 may be performed by the UE 802 in FIG. 8, which may receive side information 820, 824, or 828 associated with the UE 804. The side information 820 may be received from the network entity 806. The side information 824 may be received from the UE 804. The side information 828 may be received from the LMF 808. 1304 may also be performed by component 198 of FIG. 16.

At 1308, the first UE may receive a decoder from the first network entity. For example, 1308 may be performed by the UE 802 in FIG. 8, which may receive a decoder from the network entity 806 in the beam prediction configuration 810 or the side information 820. 1308 may also be performed by component 198 of FIG. 16.

At 1310, the first UE may decompress, based on the decoder, the side information received from the first network entity or the second UE. For example, 1310 may be performed by the UE 802, which may decompress, based on the decoder, the side information 820 received from the network entity 806 or the side information 824 received from the UE 804. 1310 may also be performed by component 198 of FIG. 16.

At 1312, the first UE may receive an encoder from the first network entity. For example, 1312 may be performed by the UE 802 in FIG. 8, which may receive an encoder from the network entity 806 in the beam prediction configuration 810 or the side information 820. 1312 may also be performed by component 198 of FIG. 16.

At 1314, the first UE may decompress, based on the encoder, the side information received from the first network entity or the second UE. For example, 1314 may be performed by the UE 802 in FIG. 8, which may decompress, based on the encoder, the side information 820 received from the network entity 806 or the side information 824 received from the UE 804. 1314 may also be performed by component 198 of FIG. 16.

At 1306, the first UE may estimate, based on the side information, one or more channel characteristics for a first set of DL RSs based on at least one of the TD beam prediction mode or the SD beam prediction mode. For example, 1306 may be performed the UE 802 in FIG. 8, which, at 830, may estimate, based on the side information 820, side information 824, or the side information 828, one or more channel characteristics for the DL RSs 832 based on at least one of the TD beam prediction mode or the SD beam prediction mode. 1306 may also be performed by component 198 of FIG. 16.

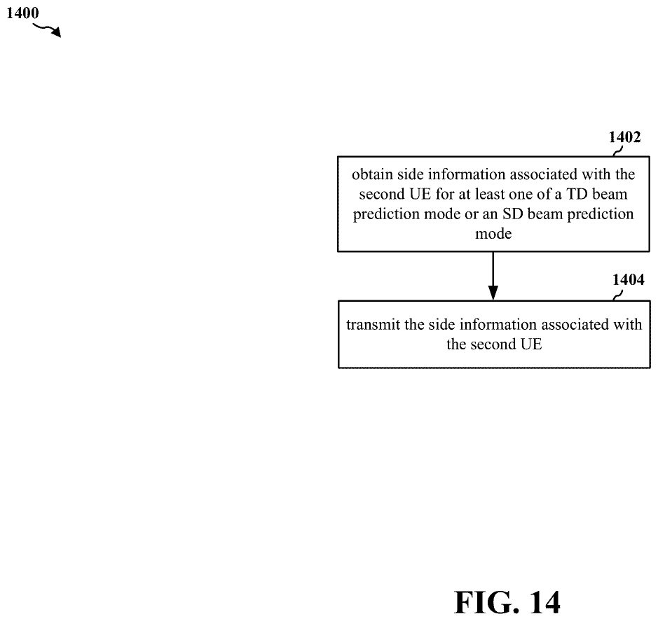

FIG. 14 is a flowchart 1400 of a method of wireless communication. The method may be performed by a second UE (e.g., the UE 104, UE 350, UE 802, UE 804, UE 904, UE 906, UE 908, UE 1004, UE 1006, UE 1008; the apparatus 1604). At 1402, the second UE may obtain side information associated with the second UE for at least one of a TD beam prediction mode or an SD beam prediction mode. For example, 1402 may be performed by the UE 804 in FIG. 8, which, at 816, may obtain side information associated with the UE 804 UE for at least one of a TD beam prediction mode or an SD beam prediction mode. 1402 may also be performed by component 197 of FIG. 16.

At 1404, the second UE may transmit the side information associated with the second UE. For example, 1404 may be performed by the UE 804 in FIG. 8, which may transmit the side information 824 associated with the UE 804 to the UE 802. The UE 804 may also transmit the side information 818 associated with the UE 804 to the network entity 806. 1404 may also be performed by component 197 of FIG. 16.

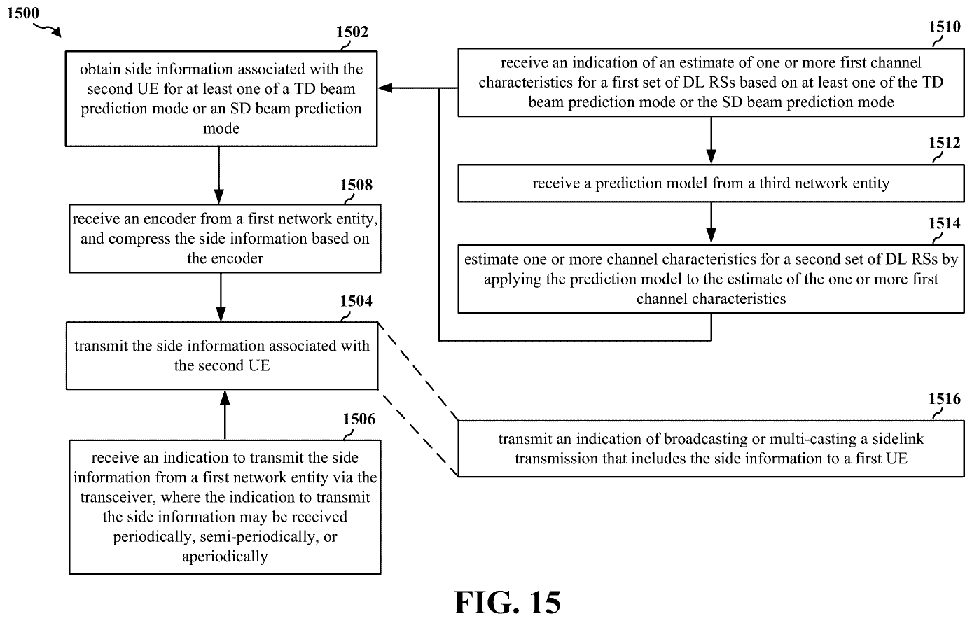

FIG. 15 is a flowchart 1500 of a method of wireless communication. The method may be performed by a second UE (e.g., the UE 104, UE 350, UE 802, UE 804, UE 904, UE 906, UE 908, UE 1004, UE 1006, UE 1008; the apparatus 1604). At 1502, the second UE may obtain side information associated with the second UE for at least one of a TD beam prediction mode or an SD beam prediction mode. For example, 1502 may be performed by the UE 804 in FIG. 8, which, at 816, may obtain side information associated with the UE 804 UE for at least one of a TD beam prediction mode or an SD beam prediction mode. 1502 may also be performed by component 197 of FIG. 16.

At 1510, the second UE may receive an indication of an estimate of one or more first channel characteristics for a first set of DL RSs based on at least one of the TD beam prediction mode or the SD beam prediction mode. For example, 1510 may be performed by the UE 802, which may receive an indication of an estimate of one or more first channel characteristics for the DL RSs 812 based on at least one of the TD beam prediction mode or the SD beam prediction mode via side information 824. 1510 may also be performed by component 197 of FIG. 16.

At 1512, the second UE may receive a prediction model from a third network entity. For example, 1512 may be performed by the UE 802 in FIG. 8, which may receive a prediction model from a network entity, such as the network entity 806. 1512 may also be performed by component 197 of FIG. 16.

At 1514, the second UE may estimate one or more channel characteristics for the first set of DL RSs by applying the prediction model to the estimate of the one or more first channel characteristics. For example, 1514 may be performed by the UE 802 in FIG. 8, which, at 803, may estimate one or more channel characteristics for the DL RSs 832 by applying the prediction model to the estimate of the one or more channel characteristics for the DL RSs 812 provided in the side information 824. 1514 may also be performed by component 197 of FIG. 16.

At 1508, the second UE may receive an encoder from a first network entity, and compress the side information based on the encoder. For example, 1508 may be performed by the UE 804 in FIG. 8, which may receive an encoder from the network entity 806 and compress the side information 824 based on the encoder. 1508 may also be performed by component 197 of FIG. 16.

At 1506, the second UE may receive an indication to transmit the side information from a first network entity. The indication to transmit the side information may be received periodically, semi-periodically, or aperiodically. For example, 1506 may be performed by the UE 804 in FIG. 8, which may receive an indication 822 to transmit from the network entity 806. The indication 822 to transmit the side information 824 may be received periodically, semi-periodically, or aperiodically. 1506 may also be performed by component 197 of FIG. 16.

At 1504, the second UE may transmit the side information associated with the second UE. For example, 1504 may be performed by the UE 804 in FIG. 8, which may transmit the side information 824 associated with the UE 804 to the UE 802. The UE 804 may also transmit the side information 818 associated with the UE 804 to the network entity 806. 1504 may also be performed by component 197 of FIG. 16.

At 1516, the second UE may transmit an indication of broadcasting or multi-casting a sidelink transmission including the side information to a first UE. For example, 1516 may be performed by the UE 804 in FIG. 8, which may transmit the side information 824 associated with the UE 804 to the UE 802 by broadcasting or multi-casting a sidelink transmission that includes the side information 824. The UE 804 may also transmit the side information 818 associated with the UE 804 to the network entity 806. 1504 may also be performed by component 197 of FIG. 16.

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRx) (or in some cases, just a receiver (Rx)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the Tx processor 368, the Rx processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see UE 350 of FIG. 3) and include the additional modules of the apparatus 1604.

As discussed supra, the component 198 is configured to receive an indication to operate in at least one of a TD beam prediction mode or an SD beam prediction mode. The indication may be received from a first network entity. The component 198 may receive side information associated with a second UE from at least one of the first network entity, the second UE, or a second network entity. The component 198 may estimate, based on the side information, one or more channel characteristics for a first set of DL RSs based on at least one of the TD beam prediction mode or the SD beam prediction mode. The component 198 may be within the cellular baseband processor 1624, the application processor 1606, or both the cellular baseband processor 1624 and the application processor 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for receiving an indication to operate in at least one of a TD beam prediction mode or an SD beam prediction mode. The apparatus 1604 may further include means for receiving side information associated with a second UE. The apparatus 1604 may further include means for estimating, based on the side information, one or more channel characteristics for a first set of DL RSs based on at least one of the TD beam prediction mode or the SD beam prediction mode. The apparatus 1604 may further include means for receiving a second set of DL RSs from the first network entity for at least one of the TD beam prediction mode or the SD beam prediction mode. The apparatus 1604 may further include means for performing at least one measurement for the second set of DL RSs in at least one of the TD beam prediction mode or the SD beam prediction mode. The apparatus 1604 may further include means for estimating the one or more channel characteristics for the first set of DL RSs based on the at least one measurement for the second set of DL RSs. The apparatus 1604 may further include means for receiving a prediction model from a third network entity. The apparatus 1604 may further include means for estimating the one or more channel characteristics for the first set of DL RSs by applying the prediction model to the side information to predict the one or more channel characteristics for the first set of DL RSs. The apparatus 1604 may further include means for transmitting an indication of the estimation of the one or more channel characteristics for the first set of DL RSs. The apparatus 1604 may further include means for receiving a decoder from the first network entity. The apparatus 1604 may further include means for decompressing, based on the decoder, the side information received from the first network entity or the second UE. The apparatus 1604 may further include means for receiving an encoder from the first network entity. The apparatus 1604 may further include means for decompressing, based on the encoder, the side information received from the first network entity or the second UE. The means may be the component 198 of the apparatus 1604 configured to perform the functions recited by the means. As described supra, the apparatus 1604 may include the Tx processor 368, the Rx processor 356, and the controller/processor 359. As such, in one configuration, the means may be the Tx processor 368, the Rx processor 356, and/or the controller/processor 359 configured to perform the functions recited by the means.

As discussed supra, the component 197 is configured to obtain side information associated with itself for at least one of a TD beam prediction mode or an SD beam prediction mode via side information component 197. The component 197 may transmit the side information associated with the UE 104. The component 197 may be within the cellular baseband processor 1624, the application processor 1606, or both the cellular baseband processor 1624 and the application processor 1606. The component 197 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for obtaining side information associated with the second UE for at least one of a TD beam prediction mode or an SD beam prediction mode. The apparatus 1604 may further include means for transmitting the side information associated with the second UE. The apparatus 1604 may further include means for receiving an indication to transmit the side information from a first network entity. The apparatus 1604 may further include means for transmitting an indication of broadcasting or multi-casting a sidelink transmission including the side information to a first UE. The apparatus 1604 may further include means for receiving an indication of an estimate of one or more first channel characteristics for a first set of DL RSs based on at least one of the TD beam prediction mode or the SD beam prediction mode. The apparatus 1604 may further include means for receiving a prediction model from a third network entity. The apparatus 1604 may further include means for estimating one or more channel characteristics for a second set of DL RSs by applying the prediction model to the estimate of the one or more first channel characteristics. The apparatus 1604 may further include means for receiving an encoder from a first network entity. The apparatus 1604 may further include means for compressing the side information based on the encoder. The means may be the component 197 of the apparatus 1604 configured to perform the functions recited by the means. As described supra, the apparatus 1604 may include the Tx processor 368, the Rx processor 356, and the controller/processor 359. As such, in one configuration, the means may be the Tx processor 368, the Rx processor 356, and/or the controller/processor 359 configured to perform the functions recited by the means.

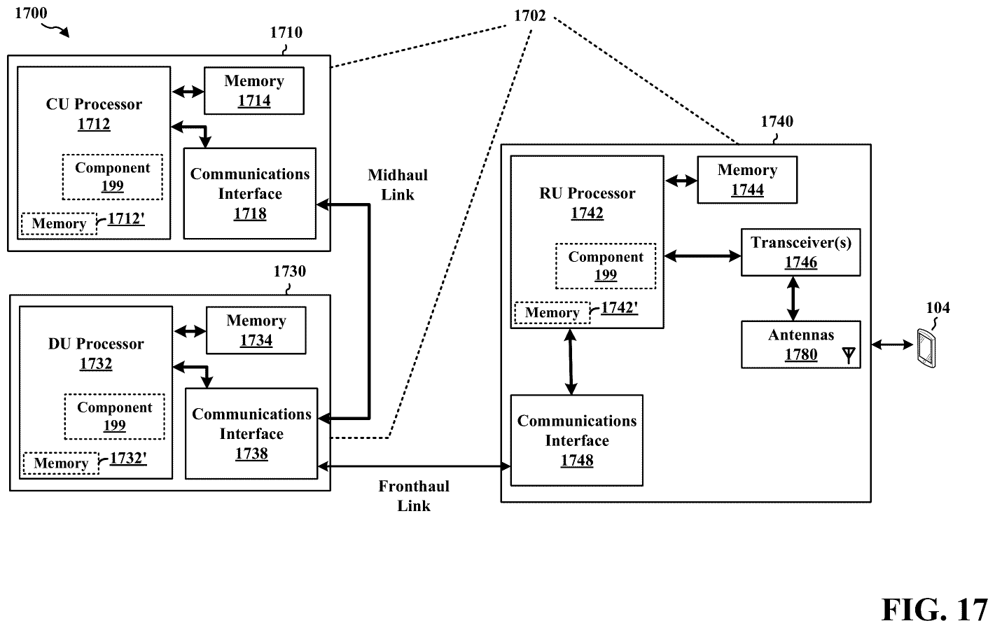

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include a CU processor 1712. The CU processor 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include a DU processor 1732. The DU processor 1732 may include on-chip memory 1732′. In some aspects, the DU 1730 may further include additional memory modules 1734 and a communications interface 1738. The DU 1730 communicates with the RU 1740 through a fronthaul link. The RU 1740 may include an RU processor 1742. The RU processor 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to transmit an indication to operate in at least one of a TD beam prediction mode or an SD beam prediction mode to a UE. The component 199 may obtain side information from a UE. The component 199 may transmit that side information to another UE. The component 199 may be within one or more processors of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 includes means for transmitting an indication to operate in at least one of a TD beam prediction mode or an SD beam prediction mode to a UE. The network entity 1702 may further include means for obtaining side information from a UE. The network entity 1702 may further include means for transmitting side information to another UE. The means may be the component 199 of the network entity 1702 configured to perform the functions recited by the means. As described supra, the network entity 1702 may include the Tx processor 316, the Rx processor 370, and the controller/processor 375. As such, in one configuration, the means may be the Tx processor 316, the Rx processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a first UE, where the method may include receiving an indication to operate in at least one of a TD beam prediction mode or an SD beam prediction mode. The indication may be received from a first network entity. The method may further include receiving side information associated with a second UE. The side information may be received from at least one of the first network entity, the second UE, or a second network entity. The method may further include estimating, based on the side information, one or more channel characteristics for a first set of DL RSs based on at least one of the TD beam prediction mode or the SD beam prediction mode.

Aspect 2 is the method of aspect 1, where the first network entity may include a base station or a component of the base station. The second network entity may include an LMF or a component of the LMF.

Aspect 3 is the method of any of aspects 1 and 2, where the method may further include receiving a second set of DL RSs from the first network entity for at least one of the TD beam prediction mode or the SD beam prediction mode. The method may further include performing at least one measurement for the second set of DL RSs in at least one of the TD beam prediction mode or the SD beam prediction mode. Estimating the one or more channel characteristics for the first set of DL RSs may be further based on the at least one measurement for the second set of DL RSs.

Aspect 4 is the method of any of aspects 1 to 3, where the method may further include receiving a prediction model from a third network entity. Estimating the one or more channel characteristics for the first set of DL RSs may include applying the prediction model to the side information to predict the one or more channel characteristics for the first set of DL RSs.

Aspect 5 is the method of any of aspects 1 to 4, where the method may further include transmitting an indication of the estimation of the one or more channel characteristics for the first set of DL RSs.

Aspect 6 is the method of any of aspects 1 to 5, where the side information associated with the second UE may be received via at least one of an RRC configuration, a MAC-CE, or DCI from the first network entity.

Aspect 7 is the method of any of aspects 1 to 6, where the side information associated with the second UE may include at least one of: (a) one or more historical characteristics of a second set of DL RSs, (b) one or more predicted characteristics of a third set of DL RSs, (c) a first channel profile between the second UE and the first network entity, (d) a second channel profile between the second UE and the first UE, (e) position information, (f) location information, or (g) mobility information.

Aspect 8 is the method of aspect 7, where the one or more historical characteristics or the one or more predicted characteristics may include at least one of: an RSRP measurement, an RS-ID, a measurement time period, a beam failure condition, or a beam blockage condition.

Aspect 9 is the method of any of aspects 7 to 8, where the first channel profile may include at least one of a PDP, an AoA, or a resource. The second channel profile may include at least one of a sidelink PDP, an AoA, or a resource.

Aspect 10 is the method of any of aspects 1 to 9, where the side information may be received via a sidelink transmission from the second UE.

Aspect 11 is the method of any of aspects 1 to 10, where the side information associated with the second UE may include at least one of position information, location information, or mobility information received from the second network entity.

Aspect 12 is the method of aspect 11, where the at least one of the position information, the location information, or the mobility information may include at least one of second position information, second location information, or second mobility information of a set of UEs. The set of UEs may include the second UE.

Aspect 13 is the method of any of aspects 1 to 12, where the side information associated with the second UE may include an LPP transmission received from the second network entity.

Aspect 14 is the method of any of aspects 1 to 13, where the method may further include receiving a decoder from the first network entity. The method may further include decompressing, based on the decoder, the side information received from the first network entity or the second UE.

Aspect 15 is the method of any of aspects 1 to 14, where the method may further include receiving an encoder from the first network entity. The method may further include decompressing, based on the encoder, the side information received from the first network entity or the second UE.

Aspect 16 is the method of any of aspects 1 to 15, where the side information may be received as a broadcast transmission or a multi-cast transmission from the first network entity or from the second UE.

Aspect 17 is a method of wireless communication at a second UE, where the method may include obtaining side information associated with the second UE for at least one of a TD beam prediction mode or an SD beam prediction mode. The method may further include transmitting the side information associated with the second UE.

Aspect 18 is the method of aspect 17, where the method may further include receiving an indication to transmit the side information from a first network entity. The indication to transmit the side information may be received periodically, semi-periodically, or aperiodically.

Aspect 19 is the method of any of aspects 17 to 18, where the method may further include transmitting an indication of broadcasting or multi-casting a sidelink transmission including the side information to a first UE.

Aspect 20 is the method of any of aspects 17 to 19, where the side information may include at least one of: (a) one or more historical characteristics of a first set of DL RSs, (b) one or more predicted characteristics of a second set of DL RSs, (c) a first channel profile between the second UE and a first network entity, (d) a second channel profile between the second UE and the first UE, (e) position information, (f) location information, or (g) mobility information.

Aspect 21 is the method of aspect 20, where the one or more historical characteristics or the one or more predicted characteristics may include at least one of an RSRP measurement, an RS-ID, a measurement time period, a beam failure condition, or a beam blockage condition.

Aspect 22 is the method of any of aspects 20 to 21, where the first channel profile may include at least one of a PDP, a AoA, or a resource. The second channel profile may include at least one of a sidelink PDP, an AoA, or a resource.

Aspect 23 is the method of any of aspects 17 to 22, where the side information may be transmitted via a sidelink transmission to a first UE.

Aspect 24 is the method of any of aspects 17 to 23, where the side information may be transmitted via an uplink transmission to a first network entity.

Aspect 25 is the method of any of aspects 17 to 24, where the method may further include receiving an indication of an estimate of one or more first channel characteristics for a first set of DL RSs based on at least one of the TD beam prediction mode or the SD beam prediction mode.

Aspect 26 is the method of aspect 25, where the method may further include receiving a prediction model from a third network entity. The method may further include estimating one or more channel characteristics for a second set of DL RSs by applying the prediction model to the estimate of the one or more first channel characteristics.

Aspect 27 is the method of any of aspects 17 to 26, where the method may further include receiving an encoder from a first network entity. The method may further include compressing the side information based on the encoder.

Aspect 28 is the method of any of aspects 17 to 27, where the second UE may include an RSU or a smart repeater.

Aspect 29 is an apparatus for wireless communication at a UE, including: a memory; and at least one processor coupled to the memory and, based at least in part on information stored in the memory, the at least one processor is configured to implement any of aspects 1 to 28.

Aspect 30 is the apparatus of aspect 29, further including at least one of an antenna or a transceiver coupled to the at least one processor.

Aspect 31 is an apparatus for wireless communication including means for implementing any of aspects 1 to 28.

Aspect 32 is a computer-readable medium (e.g., a non-transitory computer-readable medium) storing computer executable code, where the code when executed by a processor causes the processor to implement any of aspects 1 to 28.

What is claimed is:

1. An apparatus for wireless communication at a first user equipment (UE), comprising:
a memory; and
at least one processor coupled to the memory and, based at least in part on information stored in the memory, the at least one processor is configured to:
receive an indication to operate in at least one of a time domain (TD) beam prediction mode or a spatial domain (SD) beam prediction mode, wherein the indication is received from a first network entity;
receive side information associated with a second UE, wherein the side information is received from at least one of the first network entity, the second UE, or a second network entity; and
estimate, based on the side information, one or more channel characteristics for a first set of downlink (DL) reference signals (RSs) based on at least one of the TD beam prediction mode or the SD beam prediction mode.

2. The apparatus of claim 1, wherein the first network entity comprises a base station or a component of the base station, and the second network entity comprises a location management function (LMF) or a component of the LMF.

3. The apparatus of claim 1, wherein the at least one processor is further configured to:
receive a second set of DL RSs from the first network entity for at least one of the TD beam prediction mode or the SD beam prediction mode; and
perform at least one measurement for the second set of DL RSs in at least one of the TD beam prediction mode or the SD beam prediction mode, wherein estimating the one or more channel characteristics for the first set of DL RSs is further based on the at least one measurement for the second set of DL RSs.

4. The apparatus of claim 1, further comprising a transceiver coupled to the at least one processor wherein the at least one processor is further configured to receive a prediction model from a third network entity via the transceiver, wherein estimating the one or more channel characteristics for the first set of DL RSs comprises applying the prediction model to the side information to predict the one or more channel characteristics for the first set of DL RSs.

5. The apparatus of claim 1, wherein the at least one processor is further configured to:
transmit an indication of the estimation of the one or more channel characteristics for the first set of DL RSs.

6. The apparatus of claim 1, wherein the side information associated with the second UE is received via at least one of a radio resource control (RRC) configuration, a medium access control (MAC) control element (MAC-CE), or downlink control information (DCI) from the first network entity.

7. The apparatus of claim 1, wherein the side information associated with the second UE comprises at least one of: (a) one or more historical characteristics of a second set of DL RSs, (b) one or more predicted characteristics of a third set of DL RSs, (c) a first channel profile between the second UE and the first network entity, (d) a second channel profile between the second UE and the first UE, (e) position information, (f) location information, or (g) mobility information.

8. The apparatus of claim 7, wherein the one or more historical characteristics or the one or more predicted characteristics include at least one of: a reference signal received power (RSRP) measurement, a reference signal (RS) identifier (RS-ID), a measurement time period, a beam failure condition, or a beam blockage condition.

9. The apparatus of claim 7, wherein the first channel profile comprises at least one of a packet data protocol (PDP), a first angle of arrival (AoA), or a first resource, and wherein the second channel profile comprises at least one of a sidelink PDP, a second AoA, or a second resource.

10. The apparatus of claim 1, wherein the side information is received via a sidelink transmission from the second UE.

11. The apparatus of claim 1, wherein the side information associated with the second UE comprises at least one of position information, location information, or mobility information received from the second network entity.

12. The apparatus of claim 11, wherein the at least one of the position information, the location information, or the mobility information includes at least one of second position information, second location information, or second mobility information of a set of UEs, wherein the set of UEs comprises the second UE.

13. The apparatus of claim 1, wherein the side information associated with the second UE comprises a long term evolution (LTE) positioning protocol (LPP) transmission received from the second network entity.

14. The apparatus of claim 1, wherein the at least one processor is further configured to:
receive a decoder from the first network entity; and
decompress, based on the decoder, the side information received from the first network entity or the second UE.

15. The apparatus of claim 1, wherein the at least one processor is further configured to:
receive an encoder from the first network entity; and
decompress, based on the encoder, the side information received from the first network entity or the second UE.

16. The apparatus of claim 1, wherein the side information is received as a broadcast transmission or a multi-cast transmission from the first network entity or from the second UE.

17. An apparatus for wireless communication at a second user equipment (UE), comprising:
a memory; and
at least one processor coupled to the memory and, based at least in part on information stored in the memory, the at least one processor is configured to:
obtain side information associated with the second UE for at least one of a time domain (TD) beam prediction mode or a spatial domain (SD) beam prediction mode; and
transmit the side information associated with the second UE.

18. The apparatus of claim 17, further comprising a transceiver coupled to the at least one processor wherein the at least one processor is further configured to:
receive an indication to transmit the side information from a first network entity via the transceiver, wherein the indication to transmit the side information is received periodically, semi-periodically, or aperiodically.

19. The apparatus of claim 17, wherein the at least one processor is further configured to transmit an indication of broadcasting or multi-casting a sidelink transmission comprising the side information to a first UE.

20. The apparatus of claim 17, wherein the side information comprises at least one of: (a) one or more historical characteristics of a first set of DL RSs, (b) one or more predicted characteristics of a second set of DL RSs, (c) a first channel profile between the second UE and a first network entity, (d) a second channel profile between the second UE and a first UE, (e) position information, (f) location information, or (g) mobility information.

21. The apparatus of claim 20, wherein the one or more historical characteristics or the one or more predicted characteristics include at least one of a reference signal received power (RSRP) measurement, a reference signal (RS) identifier (RS-ID), a measurement time period, a beam failure condition, or a beam blockage condition.

22. The apparatus of claim 20, wherein the first channel profile comprises at least one of a packet data protocol (PDP), a first angle of arrival (AoA), or a first resource, and wherein the second channel profile comprises at least one of a sidelink PDP, a second AoA, or a second resource.

23. The apparatus of claim 17, wherein the side information is transmitted via a sidelink transmission to a first UE.

24. The apparatus of claim 17, wherein the side information is transmitted via an uplink transmission to a first network entity.

25. The apparatus of claim 17, wherein the at least one processor is further configured to:
receive an indication of an estimate of one or more first channel characteristics for a first set of DL RSs based on at least one of the TD beam prediction mode or the SD beam prediction mode.

26. The apparatus of claim 25, wherein the at least one processor is further configured to:
receive a prediction model from a third network entity; and
estimate one or more channel characteristics for a second set of DL RSs by applying the prediction model to the estimate of the one or more first channel characteristics.

27. The apparatus of claim 17, wherein the at least one processor is further configured to:
receive an encoder from a first network entity; and
compress the side information based on the encoder.

28. The apparatus of claim 17, wherein the second UE comprises a road side unit (RSU) or a smart repeater.

29. A method of wireless communication at a first user equipment (UE), comprising:
receiving an indication to operate in at least one of a time domain (TD) beam prediction mode or a spatial domain (SD) beam prediction mode, wherein the indication is received from a first network entity;
receiving side information associated with a second UE, wherein the side information is received from at least one of the first network entity, the second UE, or a second network entity; and
estimating, based on the side information, one or more channel characteristics for a first set of downlink (DL) reference signals (RSs) based on at least one of the TD beam prediction mode or the SD beam prediction mode.

30. A method of wireless communication at a second user equipment (UE), comprising:
obtaining side information associated with the second UE for at least one of a time domain (TD) beam prediction mode or a spatial domain (SD) beam prediction mode; and
transmit the side information associated with the second UE.
